(19) United States
(12) Patent Application Publication
(10) Pub. No.: US 2014/0084727 A1
(43) Pub. Date: Mar. 27, 2014

(54) ELECTRICAL GENERATOR APPARATUS, SYSTEM, METHOD, AND APPLICATIONS

(71) Applicant: Angel F. Martinez, Laredo, TX (US)

(72) Inventor: Angel F. Martinez, Laredo, TX (US)

(73) Assignee: CORNELL UNIVERSITY, ITHACA, NY (US)

(21) Appl. No.: 14/009,924

(22) PCT Filed: Apr. 5, 2012
(86) PCT No.: PCT/US12/32313

§ 371 Date: Dec. 11, 2013

Related U.S. Application Data
(60) Provisional application No. 61/472,927, filed on Apr. 7, 2011.

(51) Int. Cl. H02K 1/17

(52) U.S. Cl. CPC H02K 1/17
USPC 310/154.02

(57) ABSTRACT

An electrical generator apparatus, an electrical generator system and a method for generating electricity while using the electrical generator apparatus or the electrical generator system each include at least one hollow tubular arc component (i.e., generally a hollow tubular ring), at least one coil winding surrounding the at least a portion of the at least one hollow tubular arc component and at least one magnet movably located within a bore within the at least one hollow tubular arc component to pass through the at least one coil winding. By effecting a relative motion of the at least one magnet with respect to the at least one coil winding, an electrical output may be generated at the terminals of the at least one coil winding. The electrical generator apparatus, system and method may be particularly useful in generating electricity from water wave motion when the electrical generator apparatus is housed within a watertight enclosure that may serve as a buoy enclosure.

### CROSS-REFERENCE TO RELATED APPLICATION

This application is related to, and derives priority from, U.S. Provisional Patent Application Ser. No. 61/472,927, filed 7 Apr. 2011 and titled “Magnetic Generator, Method, and Applications,” the content of which is incorporated herein fully by reference.

### BACKGROUND

1. Field of the Invention

Embodiments relate generally to electrical generator apparatus, electrical generator systems and electrical generator methods. More particularly, embodiments relate to motion based electrical generator apparatus, electrical generator systems and electrical generator methods.

2. Description of the Related Art

Of the various types of renewable energy sources, water wave (or more particularly ocean wave) renewable energy sources are particularly desirable insofar as water wave renewable energy sources provide energy that may generally be harvested continuously throughout the day and the night. In particular, electrical energy that is extracted from such water wave renewable energy sources may be obtained with good electrical yield, and moreover such water wave renewable energy sources may often be harvested absent any negative environmental impact.

While water wave renewable energy sources are desirable within the context of renewable energy systems, water wave renewable energy sources are nonetheless not entirely without problems. In that regard, water wave renewable energy sources often require comparatively capital intensive energy conversion apparatus to convert and harvest water wave energy in the form of electrical energy.

Thus, desirable within the renewable energy field are water wave renewable energy source to electrical conversion apparatus, systems and related methods that efficiently provide electrical energy from water wave renewable energy sources.

### SUMMARY

Embodiments provide an electrical generator apparatus, a buoy including the electrical generator apparatus (i.e., a buoy enclosed electrical generator apparatus), an electrical generator system including the electrical generator apparatus and related methods for generating electricity while using the electrical generator apparatus, the buoy including the electrical generator apparatus and the system including the electrical generator apparatus. An electrical generator apparatus in accordance with the embodiments includes at least one hollow tubular arc component (i.e., that typically comprises a hollow tubular ring) that in turn includes at least one magnet located freely movable within a bore within the at least one hollow tubular arc component. The electrical generator apparatus also includes at least one coil winding located and assembled to at least one portion of the at least one hollow tubular arc component in a fashion such that the at least one magnet is movable with respect to, and through, the at least one coil winding. Embodiments may also include appropriate electrical circuitry to collect and process an electrical output from the at least one coil winding when the at least one magnet within the bore within the at least one hollow tubular arc component travels through the portion of the at least one hollow tubular arc component surrounding which is located and assembled the at least one coil winding.

When assembled into a buoy enclosure to provide the buoy enclosed electrical generator apparatus, the electrical generator apparatus in accordance with the embodiments typically includes at least three hollow tubular arc component rings that are arranged in a set of three mutually perpendicular planes to thus provide for optimal capture of water wave energy in the three dimensions of buoy motion that may typically be encountered within the context of water wave motion.

Within the context of the embodiments as described and the invention as claimed, the terminology “hollow tubular arc component” is intended to indicate an arc component formed from a hollow tubular material that need not necessarily be, but generally is, in the shape of a hollow tubular arc or a hollow tubular ring, and more particularly a hollow tubular circular ring. Thus, a “hollow tubular ring” within the context of the embodiments as described and the invention as claimed is also intended to include an elliptical ring or any other smoothly flowing enclosed hollow tubular ring shape, or segment thereof, that is not necessarily specifically circular.

A particular electrical generator apparatus in accordance with the embodiments includes at least one hollow tubular arc component. The particular electrical generator apparatus also includes at least one coil winding located surrounding at least one portion of the at least one hollow tubular arc component. The particular electrical generator apparatus also includes at least one magnet located within the at least one hollow tubular arc component and movable through the at least one coil winding.

Another particular electrical generator apparatus in accordance with the embodiments includes at least three hollow tubular arc components arranged mutually perpendicular. This other particular electrical generator apparatus also includes at least one coil winding located surrounding at least one portion of each of the at least three hollow tubular arc components. This other particular electrical generator apparatus also includes at least one magnet located within a bore within each of the at least three hollow tubular arc components and movable through each of the at least one coil windings.

A particular electrical system in accordance with the embodiments includes a buoy enclosed electrical generator apparatus integrated with at least one additional electrical generator apparatus other than another buoy enclosed electrical generator apparatus.

Another particular electrical system in accordance with the embodiments includes at least a first electrical generator apparatus and a second electrical generator apparatus. At least one of the first electrical generator apparatus and the second electrical generator apparatus includes: (1) at least one hollow tubular arc component; (2) at least one coil winding located surrounding at least one portion of the at least one hollow tubular arc component; and (3) at least one magnet located within a bore within the at least one hollow tubular arc component and movable through the at least one coil winding. This other particular electrical system also includes at least one electrical connection component for connecting at least the first electrical generator apparatus and the second electrical generator apparatus.

A particular method for generating electricity in accordance with the embodiments includes providing an electrical generator apparatus including: (1) at least one hollow tubular arc component; (2) at least one coil winding located surrounding at least one portion of the at least one hollow tubular arc component; and (3) at least one magnet located within a bore within the at least one hollow tubular arc component and movable through the at least one coil winding. The particular method also includes inducing motion of the electrical generator apparatus to move the at least one magnet through the at least one coil winding.

### BRIEF DESCRIPTION OF THE DRAWINGS

The objects, features and advantages of the embodiments are understood within the context of the Detailed Description of the Embodiments, as set forth below. The Detailed Description of the Embodiments is understood within the context of the accompanying drawings, which form a material part of this disclosure, wherein:

FIG. 1A, FIG. 1B and FIG. 1C show a schematic perspective view diagram (i.e., FIG. 1A) and two corresponding schematic cross-sectional view diagrams (i.e., FIG. 1B and FIG. 1C) of a buoy enclosed electrical generator apparatus in accordance with the embodiments.

FIG. 2A shows a photograph of a plurality of hollow tubular rings arranged within an electrical generator apparatus absent a buoy enclosure in accordance with the embodiments.

FIG. 2B shows a photograph of a buoy enclosure for a buoy enclosed electrical generator apparatus in accordance with the embodiments.

FIG. 2C and FIG. 2D show a plurality of schematic diagrams of electrical circuits that may be used in an electrical generator apparatus or a buoy enclosed electrical generator apparatus in accordance with the embodiments.

FIG. 3A, FIG. 3B, FIG. 3C, FIG. 3D, FIG. 3E, FIG. FIG. 3F, FIG. 3G and FIG. 3H show a series of photographs of various testing configurations for an electrical generator apparatus in accordance with the embodiments.

FIG. 4A, FIG. 4B, FIG. 4C, FIG. 4D, FIG. 4E, FIG. 4F, FIG. 4G, FIG. 4H, FIG. 4I, FIG. 4J, FIG. 4K, FIG. 4L, FIG. 4M and FIG. 4N show a series of graphs illustrating a plurality of test results related to performance of a buoy enclosed electrical generator apparatus in accordance with the embodiments.

FIG. 5A and FIG. 5B shows pictorial representations of a buoy enclosed electrical generator apparatus in accordance with the embodiments implemented within the context of a water body based system (FIG. 5A) and further integrated with a water body based windmill wind farm (FIG. 5B).

### DETAILED DESCRIPTION OF THE EMBODIMENTS

Embodiments provide an electrical generator apparatus, a buoy including the electrical generator apparatus (i.e., a buoy enclosed electrical generator apparatus), an electrical generator system including the electrical generator apparatus and related methods for generating electricity while using the electrical generator apparatus, the buoy including the electrical generator apparatus or the system including the electrical generator apparatus. In a fundamental form, an electrical generator apparatus in accordance with the embodiments includes at least one magnet located freely movable within a hollow tubular arc component (i.e., generally but not necessarily a hollow tubular ring or a hollow tubular circle) and having opposite polarities aligned with a path of travel within a bore within the hollow tubular arc component. The electrical generator apparatus also includes at least one coil winding located and assembled onto a location covering the hollow tubular arc component so that the at least one magnet travels through the at least one coil winding when the at least one magnet travels through the bore within the at least one hollow tubular arc component. The electrical generator apparatus in accordance with the embodiments may also include electrical circuitry to collect electricity, and store in a battery or a capacitor, that is generated incident to movement of the at least one magnet within the bore within the hollow tubular arc component with respect to the at least one coil winding that is located and assembled surrounding the hollow tubular arc component.

### I. General Structural and Materials Considerations for the Electrical Generator Apparatus

While the embodiment that follows illustrates the embodiments within the context of an electrical generator apparatus assembled within a buoy enclosure and including three mutually perpendicular hollow tubular rings each containing a plurality of repelling end-to-end magnets (or alternatively a linear magnet chain comprising a plurality of attracting magnets), the three perpendicular hollow tubular rings also including an appropriate plurality of coil windings, the embodiments in general are not intended to be so limited.

Rather, the non-limiting embodiments contemplate an operative electrical generator apparatus that may be constructed using a minimum of one hollow tubular arc component that as suggested above need not necessarily be uniformly arcing. Moreover, the non-limiting embodiments may also include more than three hollow tubular arc components or three hollow tubular rings that may be used within the context of an operable electrical generator apparatus in accordance with the embodiments.

Within the context of the embodiments, an electrical generator apparatus includes hollow tubular rings (or related hollow tubular arc components which comprise portions of hollow tubular rings) that generally have a hollow tubular ring diameter from about 10 to about 400 centimeters (or alternatively hollow tubular arc component radii from about 5 to about 200 centimeters) and a hollow tubular ring cross-section diameter from about 0.6 to about 20 centimeters that includes a hollow tubular ring wall thickness from about 0.1 to about 2 centimeters and a hollow tubular ring bore from about 0.4 to about 16 centimeters. Smaller or larger versions of the electrical generator apparatus in accordance with the embodiments may be fabricated and the dimensions are generally only limited by the availability of suitable material components (e.g., suitable magnets), by the structural integrity at any given dimension, and the commercial viability.

Moreover, a hollow tubular ring (or related hollow tubular arc component) in accordance with the embodiments may comprise any of several hollow tubular materials that are appropriately magnetically permeable. Such hollow tubular materials may include, but are not necessarily limited to organic polymer materials such as but not limited to polyolefin materials, further such as but not limited to polyethylene polymer materials, polypropylene polymer materials and perfluoropolyolefin polymer materials. Such hollow tubular materials within the context of organic polymer materials may also include, but are also not necessarily limited to, any of several nylon polymer materials and carbon fiber polymer materials. Specific selection criteria for a particular polymer material that may be used within a hollow tubular ring or related hollow tubular arc component in accordance with the embodiments may be influenced by the generally suitable physical measurements and physical characteristics of the foregoing candidate materials for forming the hollow tubular ring or hollow tubular arc component.

With respect to the magnets located and assembled within the bore within the hollow tubular ring or hollow tubular arc component within an electrical generator apparatus in accordance with the embodiments, such magnets (which may be generally but not exclusively arranged in a repelling end-to-end polarity within the bore within the hollow tubular ring or hollow tubular arc component within the electrical generator apparatus in accordance with the embodiments) may comprise magnetic materials including but not limited to neodymium, samarium-cobalt alloy, iron alloy and ceramic magnetic materials. Such magnets will typically have a length from about 0.5 to about 15.5 centimeters and a cross-sectional diameter consistent with a bore diameter of a particular hollow tubular ring or hollow tubular arc component into which the magnets are intended to be located and assembled. Also considered within the context of the embodiments is an arrangement of magnets that includes a magnet chain of attracting polarity arranged in a single chain of up to about 13 magnets and having a chain length from about 1 to about 200 centimeters.

With respect to coil windings within an electrical generator apparatus in accordance with the embodiments, a representative coil winding located and assembled surrounding and covering a particular portion of a hollow tubular ring or hollow tubular arc component within an electrical generator apparatus in accordance with the embodiments may comprise a 16 to 28 gauge copper wire or alternative conductor wire coil winding having a number of windings from about 50 to about 750 and covering a portion of the hollow tubular ring or hollow tubular arc component having a length distance from about 1 to about 20 centimeters.

Finally, while the embodiments that follow exemplify an electrical generator apparatus within the context of a buoy enclosed electrical generator apparatus intended to generate electricity incident to water wave motion, the embodiments are also not limited to this particular characteristic for electrical power generation while using an electrical generator apparatus in accordance with the embodiments.

Rather, an electrical generator apparatus in accordance with the embodiments may generate electrical power incident to appropriate water wave motion, wind motion and direct physical interaction motion relative to earth (i.e., generally human physical interaction motion relative to earth, such as but not limited to walking while wearing an electrical generator apparatus in accordance with the embodiments or kicking an object containing an electrical generator apparatus in accordance with the embodiments) with an electrical generator apparatus in accordance with the embodiments.

Moreover, an electrical generator apparatus in accordance with the embodiments need not necessarily be located within a watertight enclosure such as but not limited to a buoy enclosure. Rather, an electrical generator apparatus in accordance with the embodiments may also be enclosed within enclosures which need not necessarily be watertight. Given, the breadth of size dimensions of an electrical generator apparatus in accordance with the embodiments, electrical generator apparatus in accordance with the embodiments may include applications including but not limited to portable applications, and nominally or intended stationary applications.

### II. Description of the Buoy Enclosed Electrical Generator Apparatus

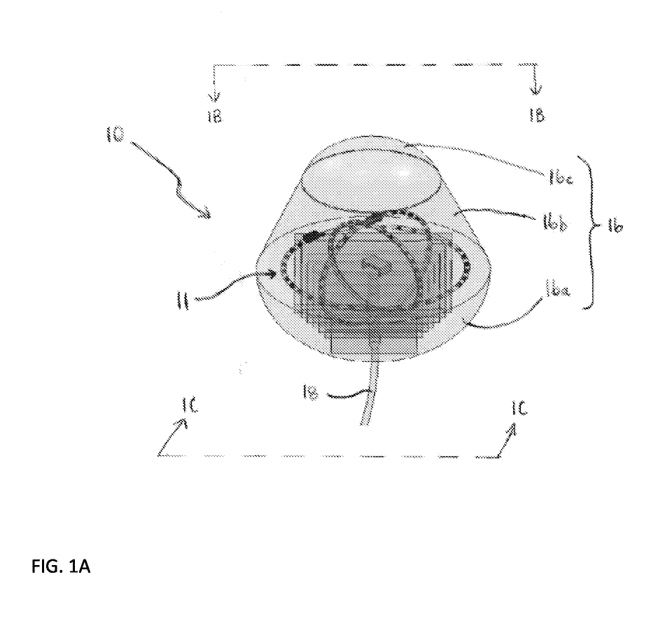

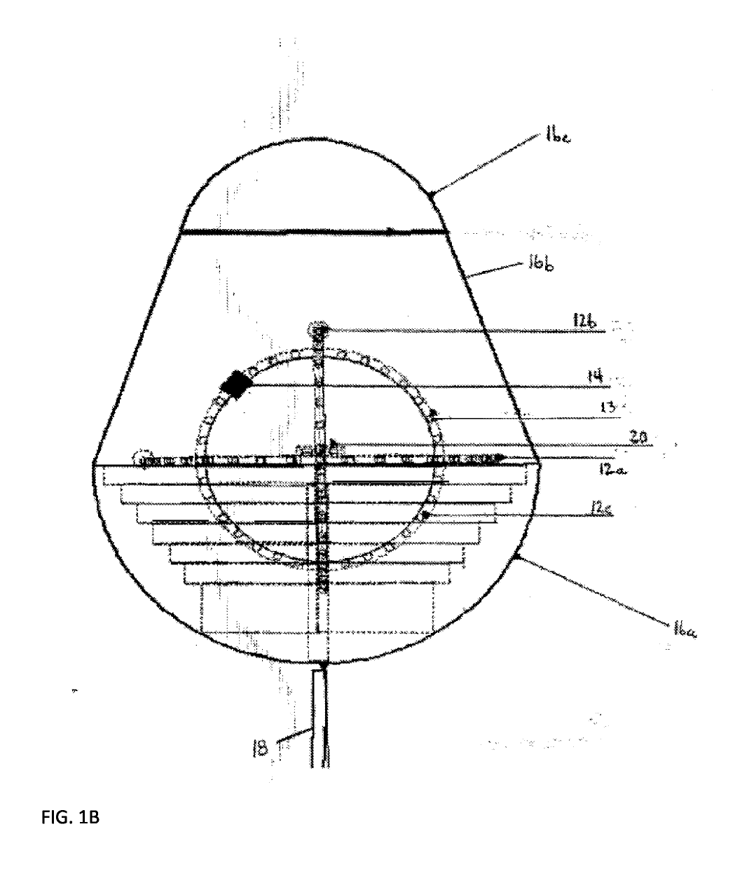

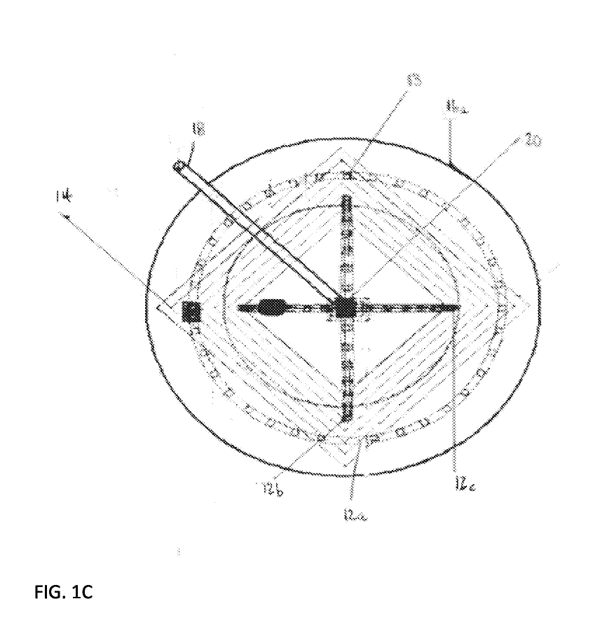

A buoy enclosed electrical generator apparatus 10 in accordance with the embodiments as illustrated in FIG. 1A includes at least two main components, of which the first main component comprises an electrical generator apparatus 11 and the second main component comprises a buoy enclosure 16, both as shown in FIG. 1A. The buoy enclosure 16 component further comprises a buoy base 16a, a buoy midsection 16b and an optional buoy cap 16c. Also illustrated within FIG. 1A is an optional tether cable 18 that is intended for at least one of: (1) a structural connection with respect to the buoy enclosure 16 and a water body floor; and (2) an electrical connection with respect to the electrical generator apparatus 11 and an electric power receiving station. In that regard, a buoy enclosed electrical generator apparatus 10 or alternative watertight enclosed electrical generator apparatus 11 in accordance with the embodiments may under certain circumstances of alternative restraint or self-powered buoy operation (or alternative self-powered watertight enclosure operation) not necessarily include the optional tether cable 18 for either of the structural connection or electrical connection purposes described above.

The two main components of the buoy enclosed electrical generator apparatus 10 are described in accordance with the foregoing reference numeral numbering scheme that is also used and illustrated within FIG. 1B, and FIG. 1C, which illustrate the two cross-sectional diagrams that correspond with the cross-sections designated within FIG. 1A. As is illustrated within FIG. 1B and FIG. 1C, the buoy enclosed electrical generator apparatus 10 comprises several hollow tubular rings 12a, 12b and 12c each one of which may house an even number of cylindrical magnets 13 arranged in a fashion such that polar ends of the same polarity for each cylindrical magnet 13 face each other. The hollow tubular rings 12a, 12b and 12c are arranged perpendicular to each other in concentric sizes as shown in FIG. 1B and FIG. 1C, with the hollow tubular ring 12a being horizontal and having a widest ring diameter and the hollow tubular ring 12c being vertical and having a narrowest ring diameter. The cylindrical magnets 13 are stacked and assembled into the hollow tubular rings 12a, 12b and 12c in mutually repelling polarities. The hollow tubular rings 12a, 12b and 12c may be dosed with graphite powder or an alternative lubricant to reduce the friction of individual cylindrical magnets 13 within the bores of the individual of the hollow tubular rings 12a, 12b and 12c.

The hollow tubular rings 12a, 12b and 12c are assembled and locked into place by using an innovative, yet simple technique and component involving concentric tubes that hold each other in place. To that end, a short segment of a hollow tube whose inner diameter is close in size to the outer diameter of the hollow tubular ring 12a, 12b or 12c holding the cylindrical magnets 13 is obtained. The short segment of the wider tube may act as a sleeve over which both ends of the smaller tube may be inserted to form an enclosed ring. They may then be held in place by a frictional force of the two plastic surfaces of the concentric hollow tubular rings tensioned against each other. The otherwise open ends of the hollow tubular rings 12a, 12b and 12c may alternatively be secured together using a suitable adhesive of composition appropriate within the context of the material from which is comprised the hollow tubular rings 12a, 12b and 12c. The outside of each hollow tubular ring 12a, 12b and 12c is then wrapped tightly with conductive wire to form a suitable number of coil windings 14. A plurality of coil windings 14 is located and assembled wrapped in various sections around each of the hollow tubular rings 12a, 12b and 12c. Generally, but not exclusively, each of the various coil windings 14 may charge an individual capacitor (or alternatively a rechargeable battery) located within a circuit or a circuit board 20 that may be contained and located in the center of the electrical generator apparatus 11 and the buoy enclosed electrical generator apparatus 10. Intended, but not limiting within the embodiments are thus several capacitors (or alternatively several rechargeable batteries) per electrical generator apparatus 11 and buoy enclosed electrical generator apparatus 10.

The buoy enclosed electrical generator apparatus 10 in accordance with the embodiments may be fabricated in at least two stages as is illustrated in FIG. 1A and FIG. 1B with respect to the buoy base 16a and the buoy midsection 16b (along with the optional buoy cap 16c). A cast and mold technique may be used for fabricating the buoy base 16a and the buoy midsection 16b which enclose the electrical generator apparatus 11 in accordance with the embodiments, as well as the optional buoy cap 16c. Alternatively, any of several other methods and materials as are conventional in the art may be used for fabricating the various components of the buoy enclosure 16. In particular, injection molding methods and materials and thermal forming methods and materials, are relevant and desirable with respect to plastic materials, polymer materials and composite materials. As well, metal forming methods and materials are common and desirable, but not limiting, of the embodiments with respect to metal materials.

For example, and without limitation, layers of polystyrene blocks may be stacked on each other to form the buoy base 16a, the buoy midsection 16b or the buoy cap 16c. Moreover, an appropriate integrity foam material (for example and without limitation 21b to 41b density urethane foam material) may then be used to fill the gaps between the layers of support blocks when fabricating the buoy base 16a, the buoy midsection 16b or the buoy cap 16c portions of the buoy enclosure 16. As is illustrated in FIG. 1A and FIG. 1B, facing portions of the buoy base 16a and the buoy midsection 16b are generally hollow to allow the component parts of the electrical generator apparatus 11 to be assembled into the buoy enclosure 16. Also included between the buoy base 16a and the buoy midsection 16b is a waterproof seal that is intended to preclude water intrusion into the hollow cavity that houses the electrical generator apparatus 11. Additionally, fiberglass cloth and associated resin may be used to seal the outer surfaces of the three components that comprise the buoy enclosure 16. Finally, the optional underwater tether cable 18 may as appropriate serve as either or both an anchor cable and as an electrical transmission line that transmits water wave generated electricity back to a centralized receiving station.

A buoy enclosed electrical generator apparatus 10 in accordance with the embodiments may also include a submergible system to serve as a protection mechanism when a buoy enclosed electrical generator apparatus 10 in accordance with the embodiments needs to be sheltered beneath overlying water waves, typically during storms. Although not specifically illustrated within the schematic diagrams of FIG. 1A and FIG. 1B, a buoy base portion 16a or a buoy cap 16c portion of a buoy enclosure 16 may also include a flood compartment with an operative number (i.e., generally at least two) of strategically placed ports to allow the buoy base 16a or the buoy cap 16c to introduce and expel water in and out of the buoy base 16a or the buoy cap 16c depending on a desired buoyancy of the buoy enclosure 16. Thus, an electrical generator apparatus 11 within a buoy enclosure 16 in accordance with the embodiments may be safely retracted below sea level by winding up a separate retracting cable (or alternatively the tether cable 18) once the buoy enclosed electrical generator apparatus 10 has reduced its buoyancy. Once a storm has passed, the retracting cable may be unwound while, for example, a pump simultaneously pumps air back into the buoy base 16a or the buoy cap 16c chamber to increase buoyancy and float the buoy enclosed electrical generator apparatus 10 back to water surface.

As indicated above, the hollow tubular rings 12a, 12b and 12c are wrapped with a plurality of coil windings 14 on the outer surface area, which itself may under certain circumstances be enclosed by metallic layer in a fashion intended to close a magnetic circuit. Although not limiting to the embodiments, each hollow tubular ring 12a, 12b or 12c may be divided into sections that charge separate capacitors or batteries in closed circuits. Although other configurations are not excluded, the capacitors or batteries may be assembled in the nucleus of the buoy enclosure 16 and the electrical generator apparatus 11. Thus, similarly with an atom, most of the buoy enclosure 16 and electrical generator apparatus 11 consists of empty space or a suitable material for support.

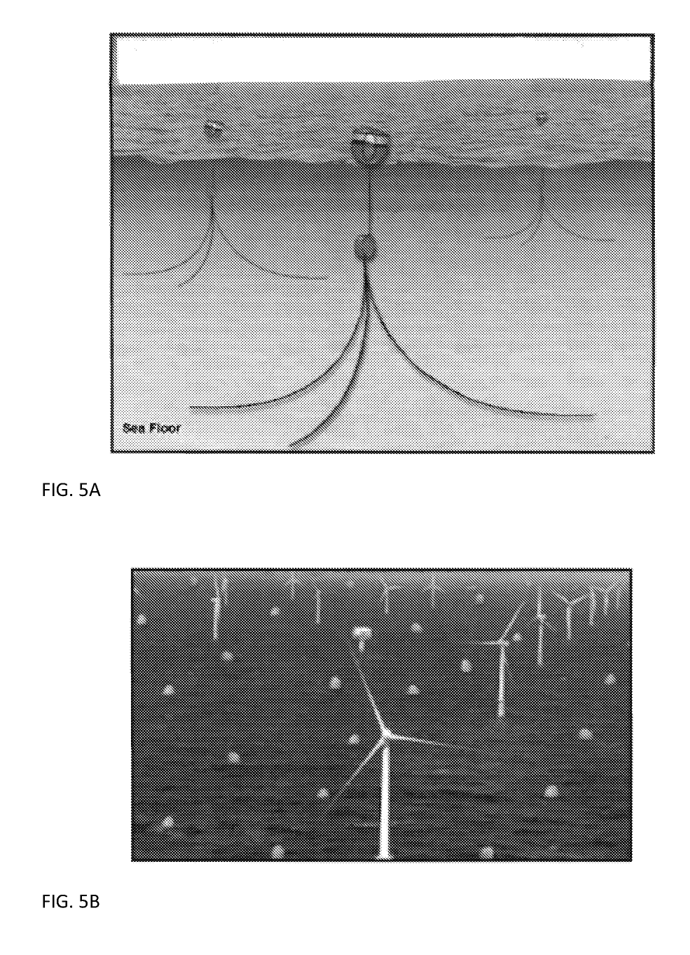

The buoy enclosed electrical generator apparatus 10 in accordance with the embodiments is relatively small by conventional standards (i.e., typically but not necessarily 1-2 m³) but has low cost of production, and is intended to be deployed as arrays of buoy enclosed electrical generator apparatus 10 (see, e.g. FIG. 5A which also show retracting apparatus for individual buoy enclosed electrical generator apparatus 10). The buoy enclosed electrical generator apparatus 10 in accordance with the embodiments may be moored at the bottom of a water body by a piezoelectric spring and a waterproof electric cable that transmits water wave generated electrical power back to shore or an intermediate relay/charging station and may be securely buried in the bottom floor of the water body. The buoy enclosed electrical generator apparatus 10 may include a circuit board/charge regulator that may react to external conditions to optimize performance, charging and discharging of capacitors or batteries at different rates based on the varying period and amplitude of water waves over time.

Desirably within the context of the embodiments, a buoy enclosed electrical generator apparatus 10 in accordance with the embodiments may harness water wave energy by moving in at least six degrees of freedom:
1. Moving up and down (heaving);
2. Moving left and right (swaying);
3. Moving forward and backward (surging);
4. Tilting forward and backward (pitching);
5. Turning left and right (yawing); and
6. Rotating clockwise and counterclockwise (spinning).

The buoy enclosure 16 of a buoy enclosed electrical generator apparatus 10 in accordance with the embodiments will receive most of the environmental induced deterioration but may be readily designed to be economically replaced and recycled. Also included may be an onboard system that may digitally scan the buoy enclosure 16 for damage and send reports to a base station for cataloging and further action. Thus, an electrical generator apparatus 11 may be repositioned from a weathered buoy enclosure 16 to a refurbished or new buoy enclosure 16 as required.

### III. Assembly of the Buoy Enclosed Electrical Generator Apparatus

The best mode of making, assembling or fabricating the buoy enclosed electrical generator apparatus 10 is to first build the electrical generator apparatus 11 according to the following process sequence:

1. Cut tube stock (i.e., generally but not exclusively polyethylene plastic tube stock) into a desired length for each of the three (or any other number) hollow tubular rings 12a, 12b and 12c.
2. Spray the inside of the cut tube stock with pressurized air to clean cutting residue and smooth the inside of tips to minimize friction.
3. Wrap coil winding 14 wire around the outside surface area of the cut tube stock tubes in desired locations and sections.
4. Close off and secure one end of the cut tube stock, and use the other end to insert cylindrical magnets 13.
5. Spray an initial amount of lubricant into the end of the cut tube stock and slide a cylindrical magnet 13 into the bore of the cut tube stock. Spray small amounts of lubricant into cut tube stock with each cylindrical magnet 13 that is inserted.
6. Continue the foregoing process sequence until a desired number of cylindrical magnets 13 is inserted into each section of cut tube stock.
7. Mate and seal ends of each section of cut tube stock to provide hollow tubular rings of various sizes, populated with appropriate numbers of cylindrical magnets 13.

The steps taken during the building of the buoy enclosure 16 may be as follows.

1. Measure circles on polystyrene (or other lightweight structural material) foam plates.
2. Cut polystyrene sections into desired dimensions and stack up in descending order of size starting with the widest in the middle plane of the buoy enclosure 16 and ending with the smallest at a bottom of the buoy enclosure 16.
3. Arrange the stacks into a mold and pour in expanding foam as cast to fill gaps in lower half of buoy enclosure 16.
4. Pour expanding foam on outer surface and sand down into desired shape of buoy enclosure 16.
5. Use resin impregnated fiberglass cloth to seal the outer surfaces of the buoy enclosure 16.
6. Install waterproof hatch near upper ⅔rds of buoy enclosure 16 where the buoy cap 16c will mate with the rest of the buoy enclosure 16.

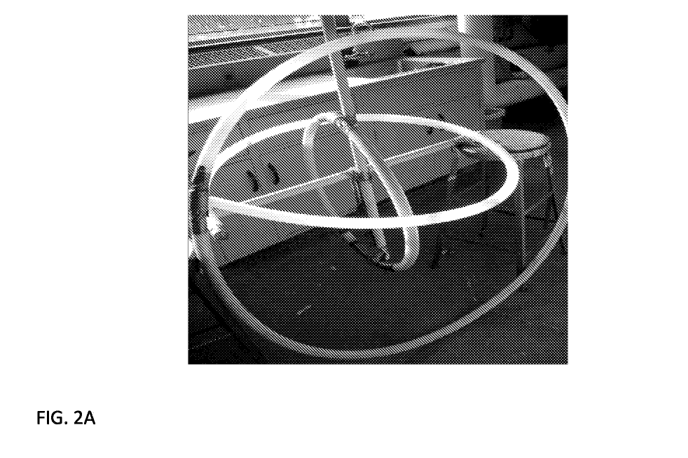

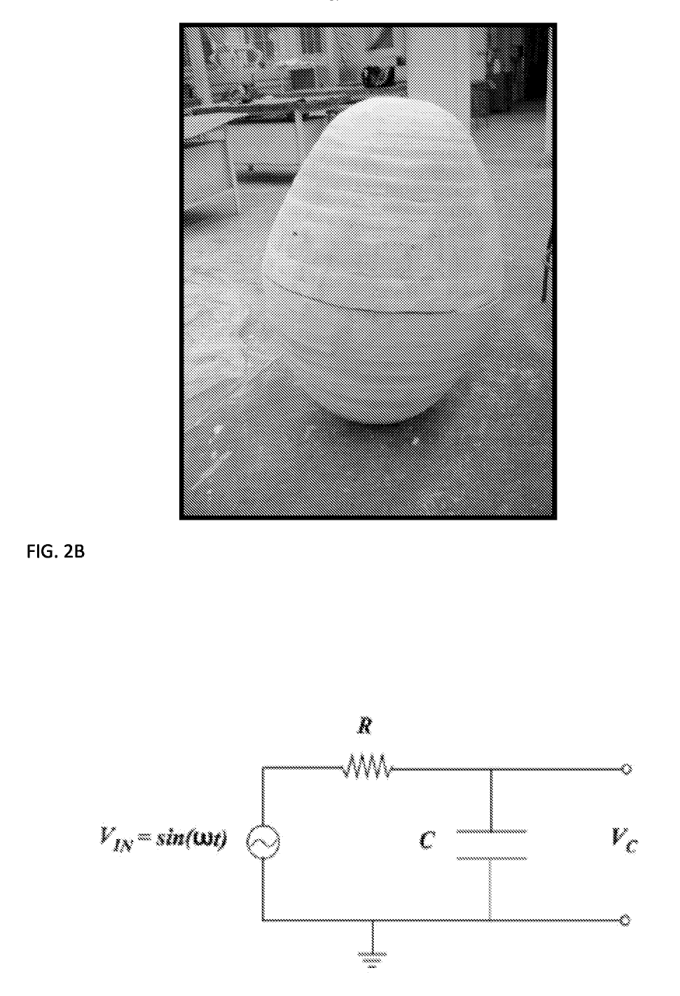

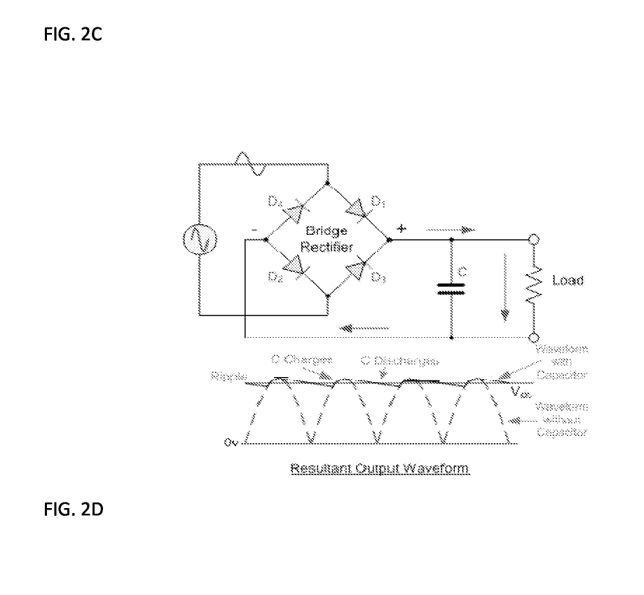

For reference purposes, FIG. 2A shows a photograph of the arranged hollow tubular rings 12a, 12b and 12c used in an electrical generator apparatus 11 in accordance with the embodiments absent a buoy enclosure 16. Similarly, FIG. 2B shows a photograph of a representative buoy enclosure 16 at an intermediate point in fabrication of the representative buoy enclosure 16.

Also for reference purposes, FIG. 2C shows a basic circuit that may be used to collect electrical energy from an operating electrical generator apparatus 11 in accordance with the embodiments. In that regard, FIG. 2C shows the circuit diagram for an RC (i.e., resistor and capacitor) circuit, where R is an external resistance, V_{IN} is a load voltage, or in this particular application a voltage developed across a coil winding 14 due to at least one moving magnet 13. C is a capacitor, which is connected in parallel with the load resistance. Lastly, V_{C} is a constant output voltage.

For additional reference purposes, FIG. 2D shows another basic circuit that may be used to collect electrical energy from an operating electrical generator apparatus 11 in accordance with the embodiments. Within this additional electrical circuit, a bridge rectifier may be used along with the capacitor that is illustrated in FIG. 2C. As is illustrated by the resultant output waveform that is also illustrated in FIG. 2D, this other basic circuit converts a sinusoidal signal, which has both positive and negative amplitudes, into a signal with positive amplitude. Thus, FIG. 2D shows operational aspects of a circuit which has both a rectifier, as well as a capacitor, along with a load. FIG. 2D also shows the transformation of waveforms while the capacitor is charging and discharging. The arrows shown in FIG. 2D indicate the direction of current flow.

### IV. Electro-Mechanical Testing of the Buoy Enclosed Electrical Generator Apparatus

### 1. First Experiments

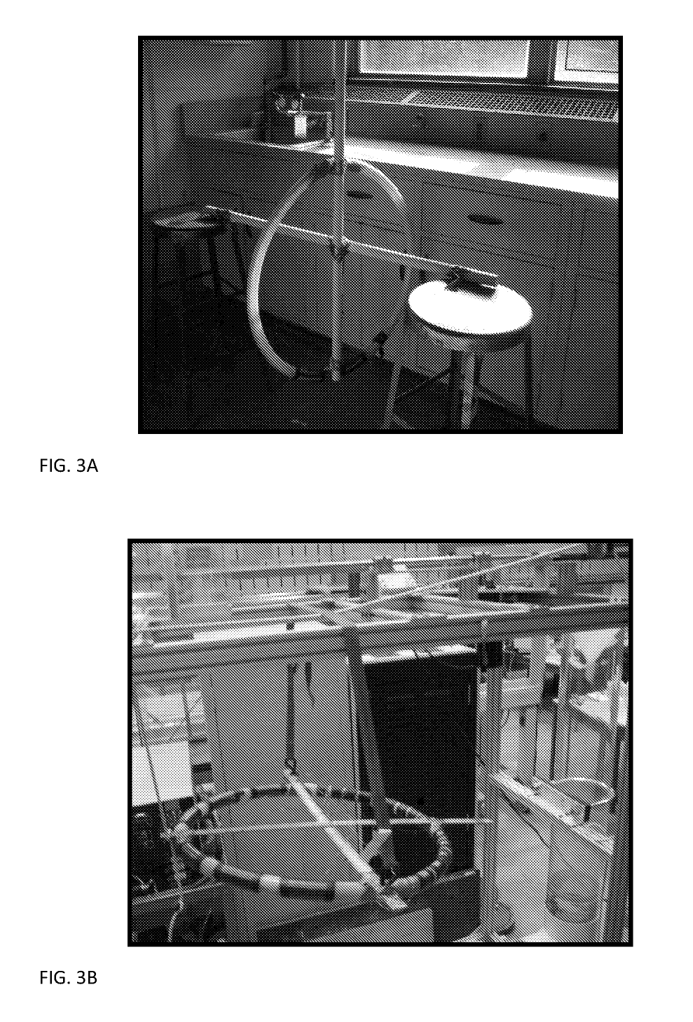

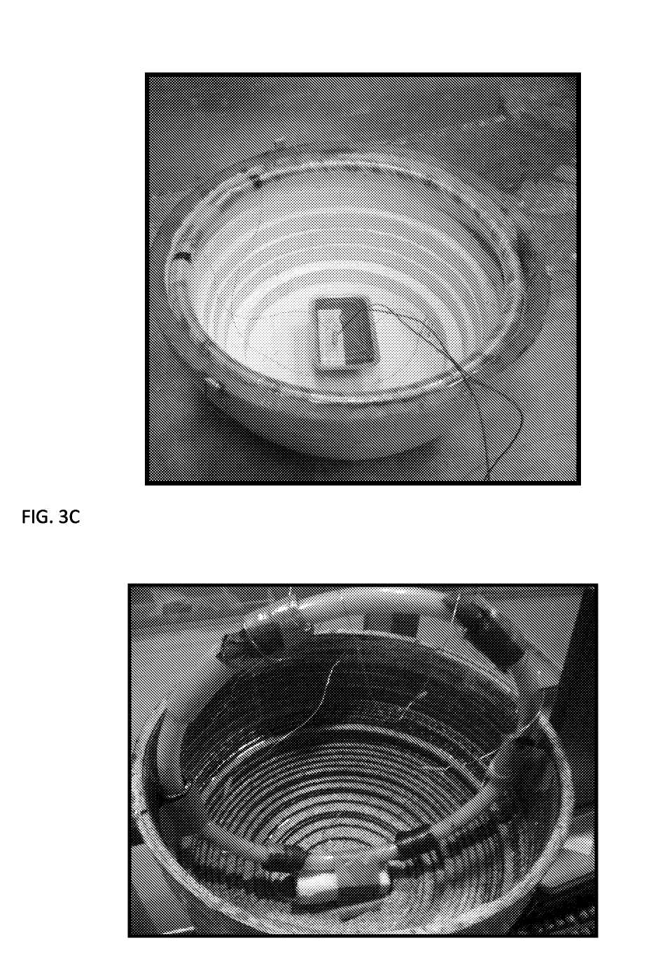

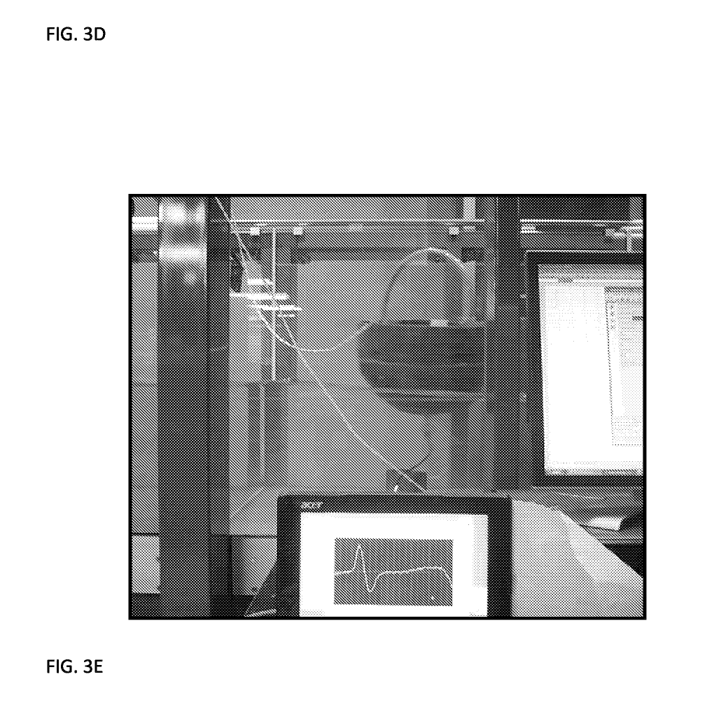

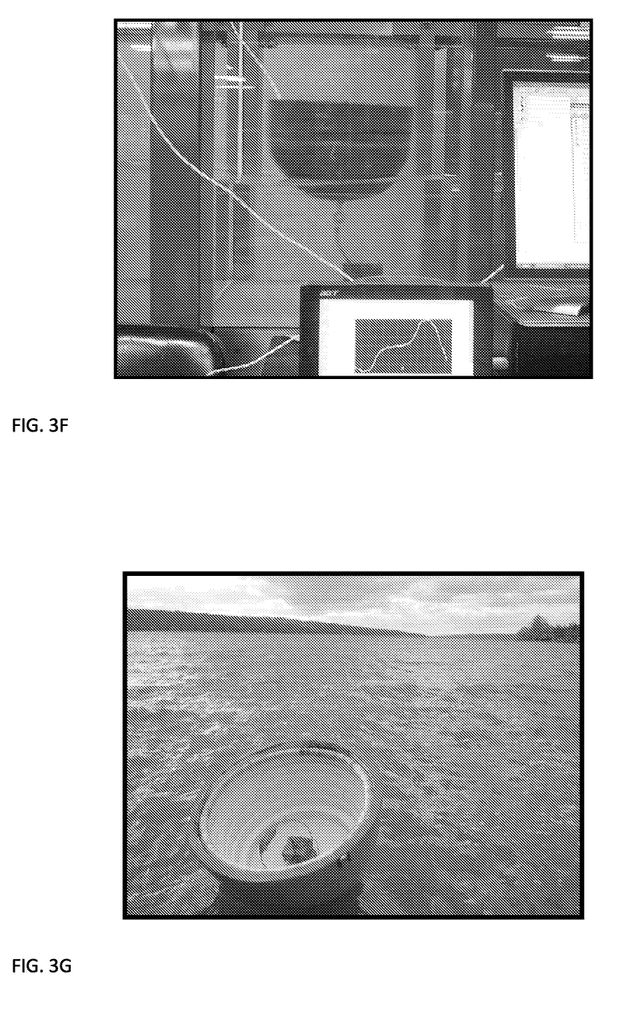

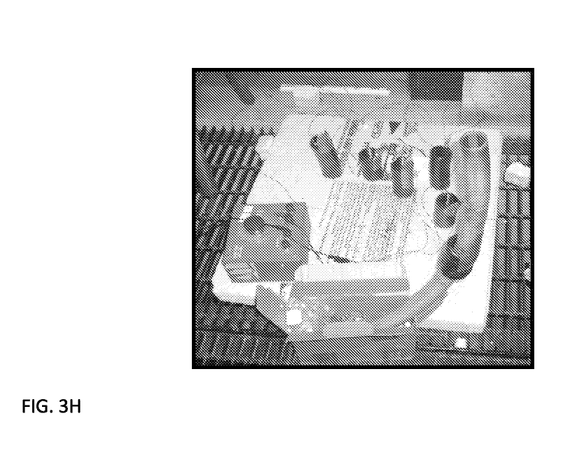

A first set of experiments was undertaken using different lengths of cut tube stock sections and different numbers of cylindrical magnets to find optimum values of each within the context of an electrical generator apparatus 11. An open circuit voltage was measured with an oscilloscope in both horizontal alignment and vertical alignment. Manual power was used to rotate the resulting hollow tubular rings that contained the magnets vertically and horizontally. Results showed that energy output of an electrical generator apparatus in accordance with the embodiments is directly related to number of magnets and speed of moving magnets within a hollow tubular ring. FIG. 3A shows an experimental configuration used in the first set of experiments.

### 2. Second Experiments

For a second set of experiments, a hollow tubular ring of the electrical generator apparatus was tested with different lengths of coil winding sections and different number of cylindrical magnets to find optimum values of energy output for a particular hollow tubular ring. An open circuit voltage was measured with an oscilloscope in both a horizontal and a vertical alignment. Mechanical pistons with various frequencies were used to rotate the hollow tubular ring and enclosed cylindrical magnets vertically and horizontally. Results showed that energy output is directly related to a range of motion of moving magnets, as anticipated. FIG. 3B shows an experimental configuration used for these second experiments with the mechanical piston.

### 3. Third Experiments

For a third set of experiments, an inner hollow tubular ring was tested inside a rocking buoy enclosure on the ground. An open circuit voltage was measured as well as a closed circuit voltage using a load resistance equal to a coil resistance. An oscilloscope was used to measure voltage in both vertical and horizontal alignments. Manual power was used to rotate the buoy base, and thus the magnets vertically and horizontally at various speeds. The range of motion was around 115 degrees. Results showed that energy output is inversely related to resistance of wire. FIG. 3C shows a ⅓^{rd} scale prototype with an inner hollow tubular ring used for these third experiments.

### 4. Fourth Experiments

For a fourth set of experiments tested was an inner most loop of an electrical generator apparatus inside a ⅙ scale buoy base section of a buoy enclosure in wave tank. Mechanical pistons were used to generate waves of different frequencies and amplitudes. An open circuit voltage was measured with an oscilloscope in vertical alignment as shown in FIG. 3D. A range of motion was around 20 degrees. An observed power output was about 5 watts for an entire hollow tubular ring with 8 cylindrical magnets. The power output recorded was limited since the waves in the tank were generally small in comparison with the size of buoy and since the motion of the buoy was restricted to 2D motion due to walls of the wave tank. The results showed that energy output is directly related to range of motion of moving magnets and number of magnets. FIG. 3E shows the experimental configuration used for these fourth experiments in the wave tank.

### 5. Fifth Experiments

For a fifth set of experiments there was tested an inner most hollow tubular ring of an electrical generator apparatus inside a ⅙ scale buoy enclosure in a wave tank. Mechanical pistons were used to generate waves of different frequencies and amplitudes. Open circuit voltage was recorded with an oscilloscope in horizontal alignment of the generator. The range of motion was around 15 degrees. Observed energy output was around 4 watts for an entire hollow tubular ring with 8 cylindrical magnets. The power output recorded was much less as waves were of limited amplitude in comparison with buoy enclosure size and buoy motion was restricted to 2D motion due to walls. The results showed that energy output is directly related to range of motion of moving magnets and number of magnets. FIG. 3F shows the experimental configuration for these fifth experiments.

### 6. Sixth Experiments

For a sixth set of experiments there was tested an innermost hollow tubular ring of an electrical generator apparatus inside a buoy base in Cayuga Lake at Ithaca, N.Y. Recorded wind speeds of up to 21 mph generated waves of small frequencies and large amplitudes. The magnet motion frequency was measured with a Fluke multi-meter in the horizontal and vertical alignment of the generator. The range of motion was around 150 degrees. Observed frequency of moving magnets was around 9 Hz for entire hollow tubular ring with 8 magnets. The frequency of the magnets motion is related to the velocity of the moving magnets. Given the strength of the magnets field, and their velocity, Faraday's Law may be used to estimate an induced electromagnetic field in the given coils. Results showed that energy output is directly related to range of motion of moving magnets and number of magnets. FIG. 3G shows the experimental configuration used for these experiments in Cayuga Lake.

### V. Results

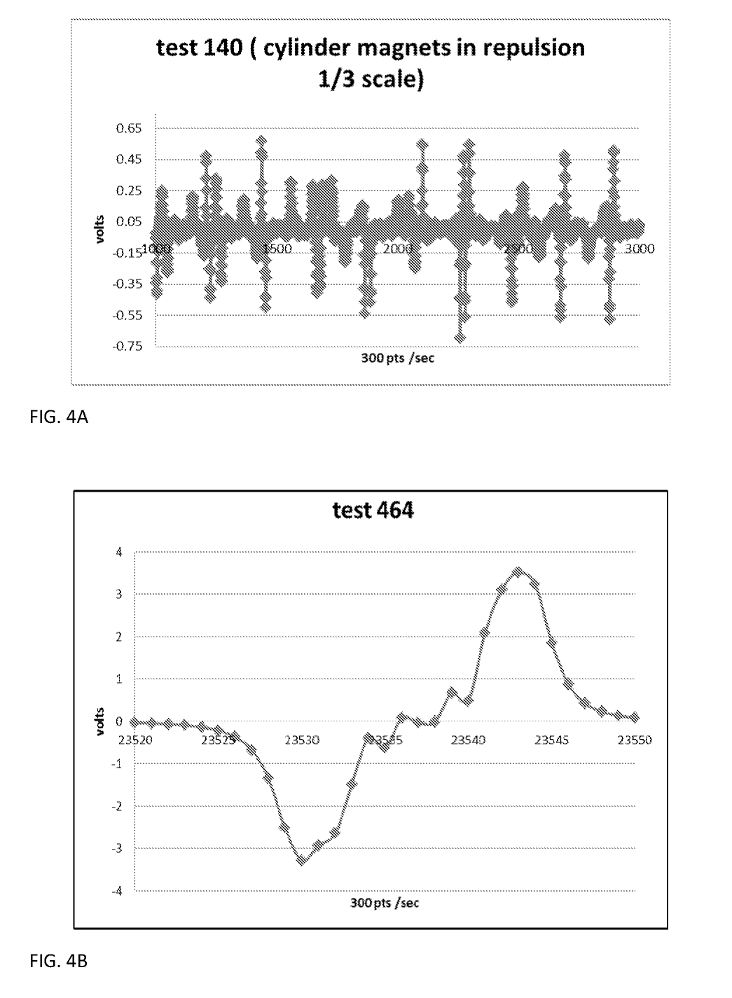

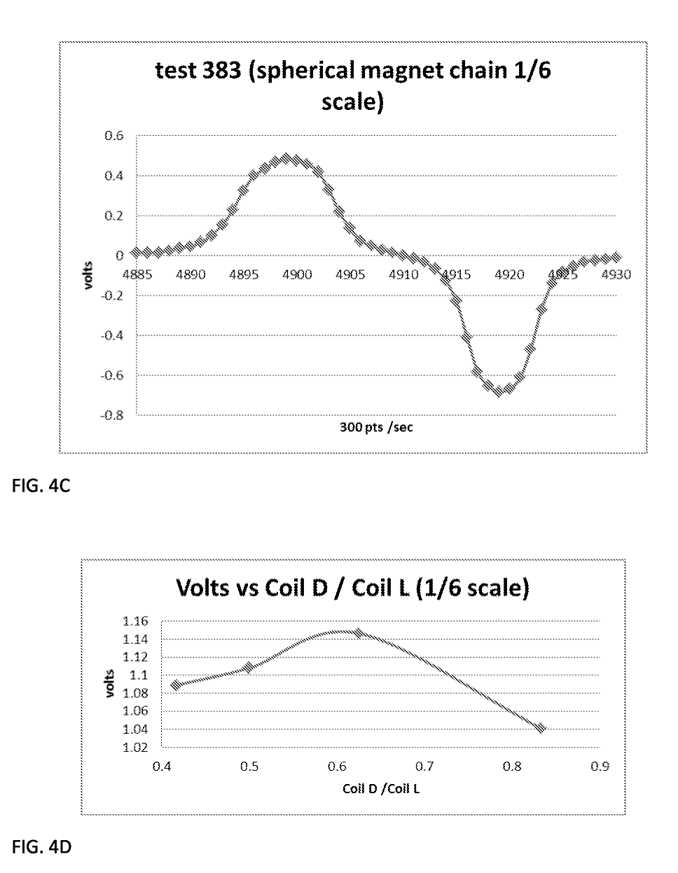

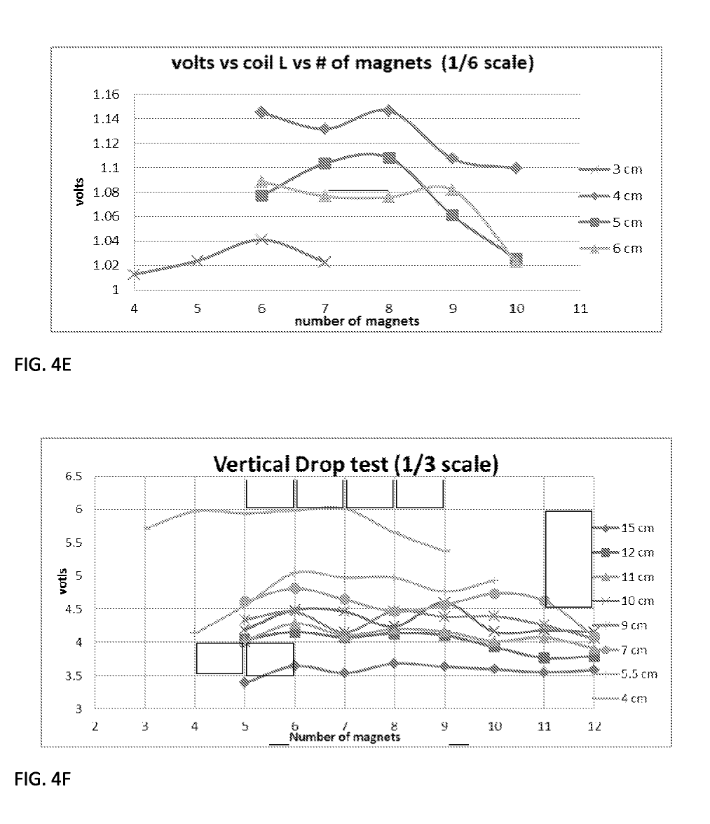

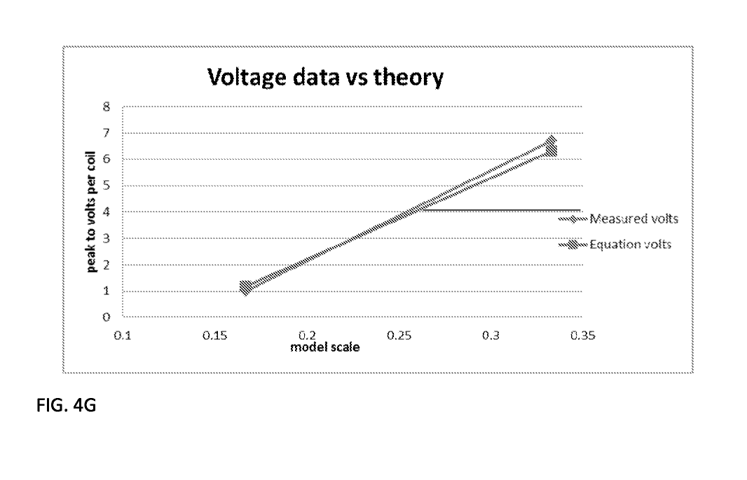

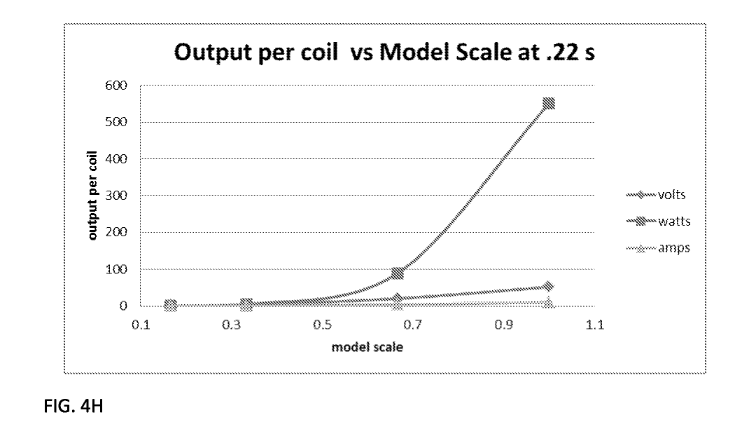

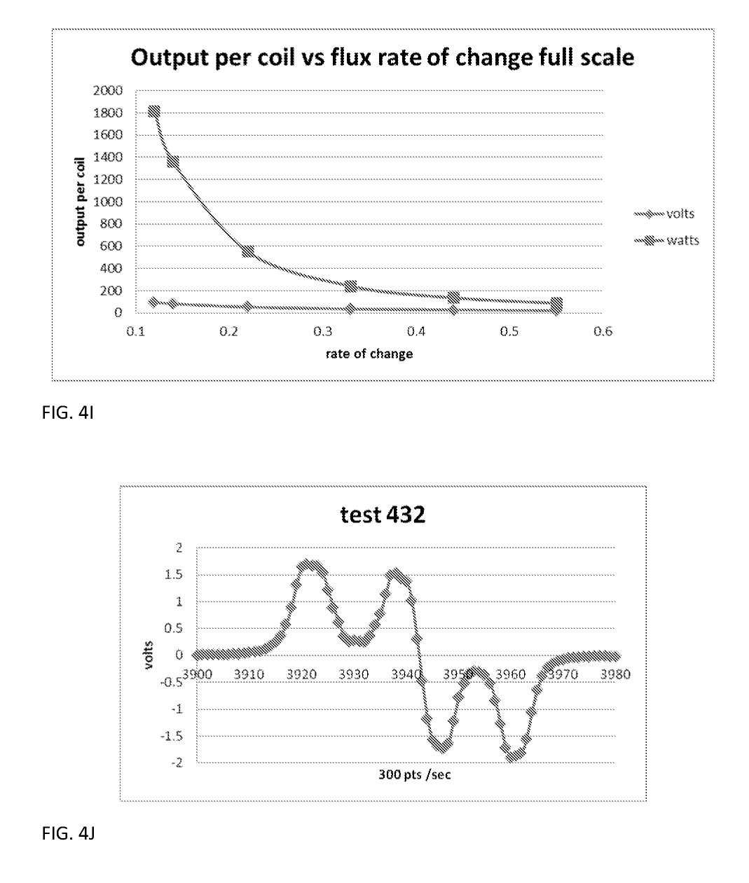

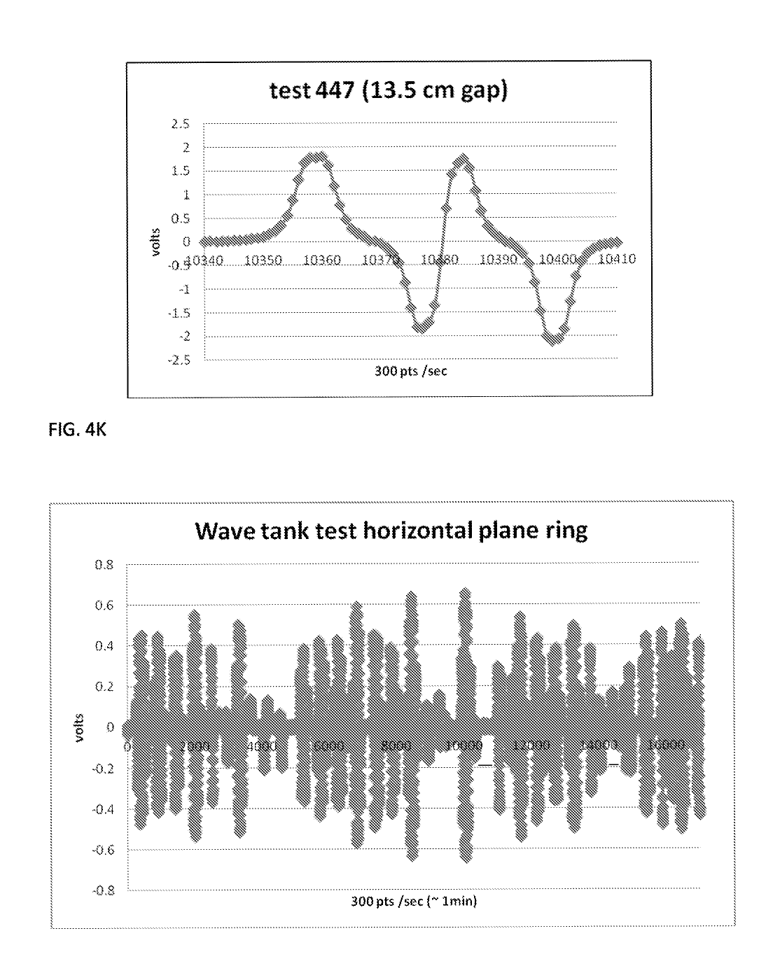

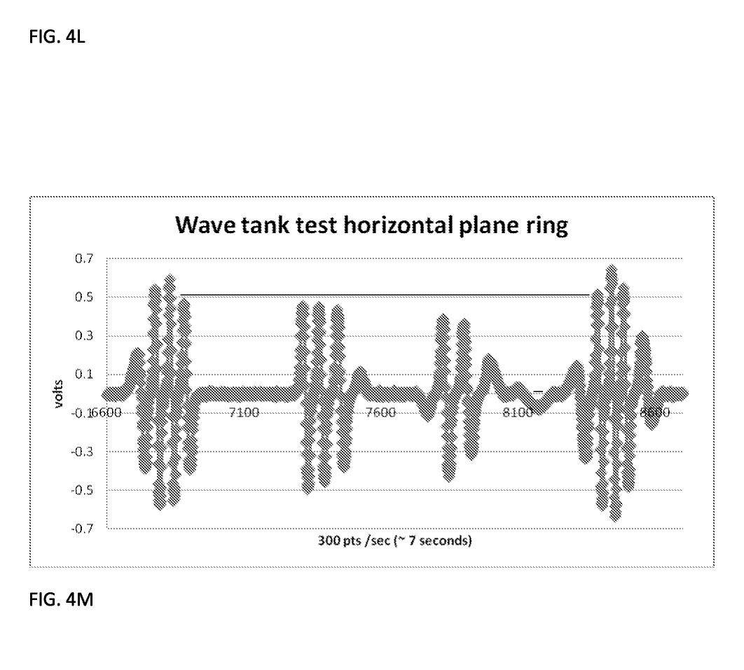

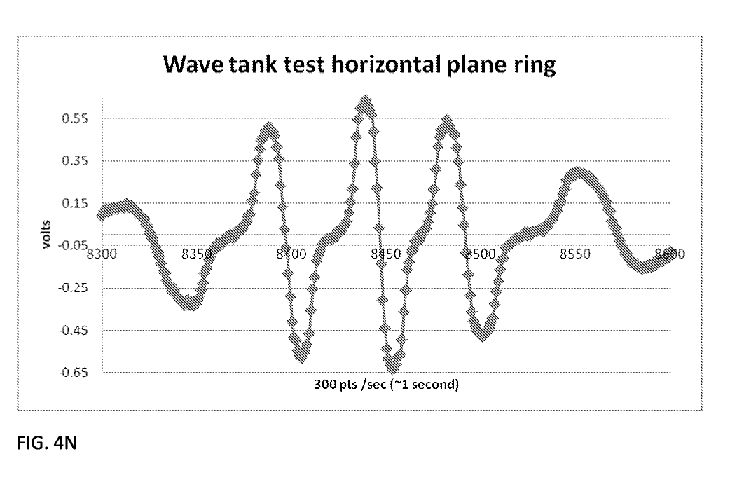

It was first observed that an electrical signal from an electrical generator apparatus in accordance with the embodiments could be enhanced by changing the properties of magnets within a hollow tubular ring from cylindrical magnets in a repulsion mode acting independently, to spherical magnets in chains. These results are observed by comparing the data of FIG. 4A with the data of FIG. 4B and FIG. 4C.

It was then also observed and determined that an output voltage of an electrical generator apparatus could be improved by varying the length of a coil winding, even when a number of magnets in a hollow tubular ring remained constant. A ratio between a coil length and a coil diameter was tested by taking voltage measurements of various coils of different lengths for spherical magnets with diameter of 1.27 cm (⅙^{th} scale). The velocity at which the magnets passed the coil was held constant by dropping the magnets from a vertical position along a segment of a tube section and hence only affected by constant acceleration of gravity as shown in FIG. 3H. The results for the highest outputs (4 magnets in the chain) are plotted in the graph of FIG. 4D, which shows a clear pattern but leaves open to question whether a true peak has been reached.

A ratio between parameters coil length and number of magnets was evaluated, tested and determined to be one important factor for an output voltage parameter as illustrated in FIG. 4E, and hence the rate of change of the magnetic flux. The testing was performed at ⅙ scale (magnet diameter of 1.27 cm) against several lengths of coils under the same conditions illustrated in FIG. 3H. A first of two observations with respect to FIG. 4E is that while improved performance is observed in reducing a length of a coil (i.e., a 4 cm coil length has a higher output than a 5 cm coil length or a 6 cm coil length), there is a cutoff point (i.e., a 3 cm coil length has the lowest output). While not limiting the embodiments, this observation may be understood by considering that a reduction in length of a coil allows magnets to pass the coil faster and hence reduce the rate of change of the flux, but in contrast too much of a reduction may have a detrimental effect on the induced flux since a number of turns in a coil has been drastically reduced. A second of two observations with respect to FIG. 4E is that each coil length has a peak (in some cases two) related to a number of magnets in a chain, which while also not limiting the embodiments may be understood by considering that the magnetic field of a magnet chain has a shape that may be ideally captured by a coil of a complimentary length.

As can been seen in FIG. 4F, an optimal voltage output results from a coil of 4 cm length and a magnet chain of 4-7 magnets.

The voltage wave for a ⅙ scale electrical generator apparatus is shown in FIG. 4C. The range of data points displayed in the graph were limited to only span the length of one voltage wave out of the set. By measuring the peak to peak voltage and the time elapsed, the power produced can be calculated for an arbitrary Test 383 as shown in Chart 1.

CHART 1
Test 383 Results

| | | |
|---|---|---|
| Peak to Peak | Voltage | 1.168 |
| | Current | 0.343 |
| | Power | 0.401 |

The voltage wave at ⅓ scale electrical generator apparatus is shown in FIG. 4B. By measuring the peak to peak voltage and the time elapsed, the power produced can be calculated for Test 464 as shown in Chart 2.

CHART 2
Test 464 Results

| | | |
|---|---|---|
| Peak to Peak | Voltage | 6.78 volts |
| Δt = 0.103 s | Current | 2.42 amps |
| | Power | 16.4 watts |

Taking the parameters of the coils (number of turns, area, and gage of wire), the magnets (diameter, velocity, and number) and the measured time elapsed for the voltage wave in the graph (rate of change of magnetic flux), one may estimate the induced voltage using equations related to Faraday's law of induction.

$$ɛ = - N \frac{d {Φ}_{B}}{d t}$$

where:
φB is the magnetic flux integrated over the coil's area, given by

$${Φ}_{B} - {\int }_{Σ ( t )}^{ } {\int }^{ } B ( r , t ) \cdot d A ,$$

and where:

A is the area of the coil perpendicular to the direction passing magnet in meters².
B(r,t) is the magnetic field of the magnet in gauss.
and the rate of change of the flux is given by the time-derivative of B flux through a possibly moving loop, with area Σ(t).

$$\frac{d {Φ}_{B}}{d t} = \frac{d}{d t} {\int }_{Σ ( t )}^{ } B ( t ) \cdot d A$$

As is illustrated in FIG. 4G, the theoretical expectations are validated by the experimental data.

Taking the same equations and extrapolating to a full scale of an electrical generator apparatus in accordance with the embodiments, estimates of an output may be made by keeping a fixed magnetic flux rate of change (0.22 s). As seen in FIG. 4H, the output increases exponentially as the full model scale (3.81 cm diameter magnet) is reached.

In contrast, FIG. 4I shows results of the output of the full scale electrical generator apparatus under varying rate of changes of magnetic flux that have been experimentally measured in a laboratory at the smaller scales. The graph of FIG. 4I shows output range from 1,800 watts to 150 watts per coil.

Experimental measurements also showed that the spacing (gap) between the coils located and assembled to a hollow tubular arc component or hollow tubular ring should be equal to or greater than the length of a magnet chain. This consideration provides for avoidance of interference of voltage sine waves within a circuit, as illustrated by the comparison between the graph of FIG. 4J where the gap space between successive coils was half the length of the magnet chain, and the graph of FIG. 4K, where the gap between successive coils was larger than the length of the magnet chain.

Finally, experimental measurements in successively amplified scale are illustrated in FIG. 4L, FIG. 4M and FIG. 4N for output from a horizontal hollow tubular ring within a scaled electrical generator apparatus in accordance with the embodiments. The data as illustrated in FIG. 4L, FIG. 4M and FIG. 4N was collected for a ⅙^{th} scale electrical generator apparatus with six coils in series on a single hollow tubular ring assembled in a horizontal plane within the electrical generator apparatus, and also using a 5 magnet chain.

### VII. Renewable Energy System Implementations

FIG. 5A shows a diagrammatic representation of a preferred implementation of a plurality of buoy enclosed electrical generator apparatus in accordance with the embodiments as an array system within a water body (i.e., an ocean or a sea, where the “array” aspects are intended to suggest or indicate a spatial relationship between each of the plurality of electrical generator apparatus and the “system” aspects are intended to suggest or indicate an interconnection relationship between each of the plurality of electrical generator apparatus). As is illustrated within FIG. 5A, each buoy enclosed electrical generator apparatus is moored to the water body floor by, for example, three cables which are attached to a retractor apparatus to which in turn is connected the buoy enclosed electrical generator apparatus.

FIG. 5B shows a diagrammatic representation of an ocean based windmill wind power farm having interposed therein an array system of buoy enclosed electrical generator apparatus in accordance with the embodiments, to thus provide an enhanced renewable electric power generation per unit area of sea floor. Within FIG. 5B, alternative operative buoy enclosed electrical generator apparatus constructions in comparison with the buoy enclosed electrical generator apparatus in accordance with the embodiments are presumably also operative, and thus may presumably also be used in place of the buoy enclosed electrical generator apparatus in accordance with the embodiments. Such alternative operative buoy enclosed electrical generator apparatus may include, but are not necessarily limited to a suitably adapted buoy enclosed electrical generator apparatus as illustrated in: (1) U.S. Pat. No. 4,423,334 issued to Jacobi et al.; (2) U.S. Pat. No. 4,492,875 issued to Rowe; (3) U.S. Pat. No. 7,989,975 issued to Clement et al.; and (4) U.S. Pat. No. 8,022,563 issued to Lemieux, the contents of all of which foregoing references is incorporated herein fully by reference.

The particular buoy enclosed electrical generator apparatus systems as illustrated in FIG. 5A and FIG. 5B are not intended to limit the embodiments with respect to at least FIG. 5B, but rather serve only as example embodiments of particular systems that may be envisioned within the context of the embodiments. For example, further embodiments may contemplate integration of an electrical generator apparatus in accordance with the embodiments with or without a buoy enclosure, with other renewable energy conversion apparatus, such as but not limited to geothermal apparatus and solar conversion apparatus, within a single physical component or within separate physical components. The generator's electrical circuit may, or may not, include an energy storing component such as a battery or a capacitor.

Although not specifically illustrated within the diagrammatic representations of FIG. 5A and FIG. 5B, the buoy enclosed electrical generator apparatus in accordance with the embodiments, as well as the other renewable energy conversion apparatus such as but not limited to the ocean based windmill wind power farm, are connected and interconnected with at least one electrical connector component, such as but not limited to an electrical cable connector component, that is otherwise generally conventional in the relevant art. Other electrical connector components and electrical connector apparatus, such as but not limited to wireless electrical connector components and apparatus, are also not precluded.

All references, including publications, patent applications, and patents cited herein are hereby incorporated by reference in their entireties to the extent allowed, and as if each reference was individually and specifically indicated to be incorporated by reference and was set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening.

The recitation of ranges of values herein is merely intended to serve as a shorthand method of referring individually to each separate value falling within the range, unless otherwise indicated herein, and each separate value is incorporated into the specification as if it was individually recited herein.

All methods described herein may be performed in any suitable order unless otherwise indicated herein or otherwise clearly contradicted by context. The use of any and all examples, or exemplary language (e.g., “such as”) provided herein, is intended merely to better illuminate embodiments of the invention and does not impose a limitation on the scope of the invention unless otherwise claimed.

No language in the specification should be construed as indicating any non-claimed element as essential to the practice of the invention.

It will be apparent to those skilled in the art that various modifications and variations can be made to the present invention without departing from the spirit and scope of the invention. There is no intention to limit the invention to the specific form or forms disclosed, but on the contrary, the intention is to cover all modifications, alternative constructions, and equivalents falling within the spirit and scope of the invention, as defined in the appended claims. Thus, it is intended that the present invention cover the modifications and variations of this invention provided they come within the scope of the appended claims and their equivalents.

What is claimed is:

1. An electrical generator apparatus comprising:
at least one hollow tubular arc component;
at least one coil winding located surrounding at least one portion of the at least one hollow tubular arc component; and
at least one magnet located within a bore within the at least one hollow tubular arc component and movable through the at least one coil winding.

2. The electrical generator apparatus of claim 1 wherein the at least one hollow tubular arc component comprises at least one hollow tubular ring.

3. The electrical generator apparatus of claim 1 wherein the at least one hollow tubular arc component comprises at least one hollow tubular circle.

4. The electrical generator apparatus of claim 2 wherein the at least one hollow tubular ring includes:
a ring diameter from about 10 to about 400 centimeters;
a bore diameter from about 0.4 to about 16 centimeters.

5. The electrical generator apparatus of claim 1 wherein the at least one coil winding has a length from about 1 to about 20 centimeters.

6. The electrical generator apparatus of claim 1 wherein the at least one magnet comprises a magnetic material selected from the group consisting of neodymium, samarium-cobalt alloy, iron alloy and ceramic magnetic materials.

7. The electrical generator apparatus of claim 1 wherein the at least one magnet comprises a plurality of magnets arranged with the same poles repelling.

8. The electrical generator apparatus of claim 1 wherein the at least one magnet comprises a plurality of magnets arranged with opposite poles attracting.

9. The electrical generator apparatus of claim 1 wherein the electrical generator apparatus includes at least three hollow tubular rings.

10. The electrical generator apparatus of claim 9 wherein the at least three tubular rings are arranged in mutually perpendicular directions.

11. The electrical generator apparatus of claim 1 further comprising an electrical circuit adapted to receive electrical power from the at least one coil winding, the electrical circuit including a capacitor.

12. The electrical generator apparatus of claim 1 further comprising an enclosure enclosing the at least one hollow tubular arc component, the at least one coil winding and the at least one magnet.

13. The electrical generator apparatus of claim 12 wherein the enclosure comprises other than a watertight enclosure.

14. The electrical generator apparatus of claim 12 wherein the enclosure comprises a watertight enclosure.

15. The electrical generator apparatus of claim 14 wherein the watertight enclosure comprises a buoy enclosure.

16. The electrical generator apparatus of claim 15 further comprising a retracting apparatus for retracting the buoy enclosure beneath a water body surface.

17. An electrical generator apparatus comprising:
at least three hollow tubular arc components arranged mutually perpendicular;
at least one coil winding located surrounding at least one portion of each of the at least three hollow tubular arc components; and
at least one magnet located within a bore within each of the at least three hollow tubular arc components and movable through each of the at least one coil windings.

18. An electrical system comprising a buoy enclosed electrical generator apparatus integrated with an additional electrical generator apparatus other than another buoy enclosed electrical generator apparatus.

19. The electrical system of claim 18 wherein the additional electrical generator apparatus comprises a windmill.

20. The electrical system of claim 18 wherein the additional electrical generator apparatus comprises a solar cell.

21. The electrical system of claim 18 wherein the electrical system is deployed in a water body.

22. An electrical system comprising:
at least a first electrical generator apparatus and a second electrical generator apparatus, at least one of the first electrical generator apparatus and the second electrical generator apparatus comprising:
at least one hollow tubular arc component;
at least one coil winding located surrounding at least one portion of the at least one hollow tubular arc component; and
at least one magnet located within a bore within the at least one hollow tubular arc component and movable through the at least one coil winding; and
at least one electrical connection component for connecting at least the first electrical generator apparatus and the second electrical generator apparatus.

23. The electrical system of claim 22 wherein the at least one of the first electrical generator apparatus and the second electrical generator apparatus is enclosed within a buoy enclosure.

24. The electrical system of claim 22 wherein each of the first electrical generator apparatus and the second electrical generator apparatus comprises:
at least one hollow tubular arc component;
at least one coil winding located surrounding at least one portion of the at least one hollow tubular arc component; and
at least one magnet located within the bore within the at least one hollow tubular arc component and movable through the at least one coil winding.

25. The electrical system of claim 22 wherein at least the second electrical generator apparatus comprises other than:
at least one hollow tubular arc component;
at least one coil winding located surrounding at least one portion of the at least one hollow tubular arc component; and
at least one magnet located within the bore within the at least one hollow tubular arc component and movable through the at least one coil winding.

26. The electrical system of claim 25 wherein at least the second electrical generator apparatus comprises at least one of a windmill and a solar cell.

27. A method for generating electricity comprising:
providing an electrical generator apparatus comprising:
at least one hollow tubular arc component;
at least one coil winding located surrounding at least one portion of the at least one hollow tubular arc component; and
at least one magnet located within a bore within the at least one hollow tubular arc component and movable through the at least one coil winding; and
inducing motion of the electrical generator apparatus to move the at least one magnet through the at least one coil winding.

28. The method of claim 27 wherein the inducing motion is provided by mechanical motion relative to earth.

29. The method of claim 27 wherein the inducing motion is provided by wave motion.

30. The method of claim 27 wherein the inducing motion is provided by wind motion.
